(19) United States
(12) Patent Application Publication
(10) Pub. No.: US 2013/0080904 A1
(43) Pub. Date: Mar. 28, 2013

(54) NETWORK MANAGEMENT APPARATUS AND METHOD OF CONTROLLING THE SAME

(71) Applicant: Tae Kook KONG, Suwon-si (KR)

(72) Inventor: Tae Kook KONG, Suwon-si (KR)

(73) Assignee: Samsung Electronics Co., Ltd., Suwon-si (KR)

(21) Appl. No.: 13/610,336

(22) Filed: Sep. 11, 2012

(30) Foreign Application Priority Data
Sep. 26, 2011 (KR) 10-2011-0097034

(51) Int. Cl. G06F 3/01

(52) U.S. Cl. 715/738

(57) ABSTRACT

A network management apparatus to display information about network equipment using an intuitive user interface includes a control unit to determine the total number of pages based on the number of pieces of network equipment, and determine a length of a scroll button region corresponding to one page based on a length of an entire movement region of a scroll button and the total number of pages, the entire movement region being divided into a plurality of scroll button regions; a storage unit to respectively associate the scroll button regions with corresponding pages and store the association result; and a display unit, in response to movement of the scroll button to a specific scroll button region, to display, on the screen thereof, network equipment information corresponding to the page associated with the specific scroll button region.

### CROSS-REFERENCE TO RELATED APPLICATIONS

This application claims the priority benefit of Korean Patent Application No. 10-2011-0097034, filed on Sep. 26, 2011 in the Korean Intellectual Property Office, the disclosure of which is incorporated herein by reference.

### BACKGROUND

1. Field

The following description relates to a network management apparatus to manage pieces of network equipment distributed over a network, and a method of controlling the same.

2. Description of the Related Art

When managing a plurality of network equipment, such as printers, for example, distributed over a network, information about searched network equipment is displayed for a network administrator or a network equipment user. A large number, for example, several thousands of pieces of network equipment may be managed using a single network management system. In this case, as the number of pieces of searched network equipment and associated information displayed on a single screen of the network management system increases, display performance of the screen deteriorates accordingly.

To solve this problem, in one conventional approach, the number of pieces of network equipment and thus associated information displayed on a single page of the screen is limited, and a link section, including a combination of a page number and page changing arrows, is displayed at a lower portion of the screen. When clicking on one of the page changing arrows and thus a changed page number, the screen may display the page corresponding to the changed page number. However, for this approach, when the number of pages is large, the link section must be clicked on many times in order to display a desired page. Moreover, this approach may not provide an intuitive user interface by which the network administrator or network equipment user may intuitively determine a location of a current page relative to all pages.

In another approach, when looking up a desired page, information about the network equipment with lists of small-numbers are initially displayed on the screen and, then, as a user scrolls down the screen using a scroll button, information about the network equipment with lists of incremental numbers are newly displayed on the screen. However, for this approach, a location of a current page relative to all pages may not be determined based on the location of the scroll button. Moreover, it may be difficult to quickly turn to the last page.

### SUMMARY

Therefore, it is one aspect to provide a network management apparatus to display information about pieces of network equipment distributed over a network using an intuitive user interface and a method of controlling the same.

Additional aspects will be set forth in part in the description which follows and, in part, will be obvious from the description, or may be learned by practice of the invention.

In accordance with one aspect, there is provided a method of controlling a network management apparatus having a screen to display information about each piece of network equipment and a scroll button on the screen to enable a change of the screen in displaying the network equipment information. The method includes determining a total number of pages to display the network equipment information based on the number of pieces of network equipment; determining a length of a scroll button region corresponding to one page based on a length of an entire movement region of the scroll button and the total number of pages, the entire movement region being divided into a plurality of scroll button regions; respectively associating the scroll button regions with corresponding pages and storing the association result; and in response to a movement of the scroll button to a specific scroll button region, displaying, on the screen, the network equipment information corresponding to the page associated with the specific scroll button region.

Determining the total number of pages may include determining the number of pieces of network equipment, information about which is able to be displayed on one page of the screen; and determining the total number of pages by dividing the total number of pieces of network equipment by the number of pieces of network equipment, information about which is able to be displayed on one page of the screen.

Determining the number of pieces of network equipment, information about which is able to be displayed on one page of the screen, may include determining the number of pieces of network equipment, information about which is able to be displayed on one page of the screen, by dividing a vertical or horizontal length of the screen by a vertical or horizontal length of one display block to display information about one piece of network equipment.

The method may further include, when a size of the screen is changed in a state of displaying on the screen the network equipment information corresponding to the page associated with the specific scroll button region, re-determining the total number of pages in accordance with the changed size of the screen.

Re-determining the total number of pages in accordance with the changed size of the screen may include determining the number of pieces of network equipment, information about which is able to be displayed on one page of the screen having the changed size; and determining the total number of pages by dividing the total number of pieces of network equipment by the number of pieces of network equipment, information about which is able to be displayed on one page of the screen having the changed size.

The method may further include, when the number of pieces of network equipment, information about which is able to be displayed on one page of the screen having the changed size is determined, displaying information about the determined number of pieces of network equipment on the screen having the changed size.

Displaying information about the determined number of pieces of network equipment on the screen having the changed size may include displaying information about the network equipment disposed at the highest block of the screen prior to the size change of the screen within the screen having the changed size.

The method may further include re-determining a length of a scroll button region corresponding to one page of the screen having the changed size based on a length of an entire movement region of the scroll button and the re-determined total number of pages.

The method may further include respectively re-associating the scroll button regions, each region having the re-determined length, with corresponding pages of the re-determined total number of pages and storing the re-association result.

In accordance with one aspect, there is provided a network management apparatus having a screen to display information about each piece of network equipment and a scroll button on the screen to enable a change of the screen in displaying the network equipment information. The apparatus includes a control unit to determine the total number of pages to display the network equipment information based on the number of pieces of network equipment, and determine a length of a scroll button region corresponding to one page based on a length of an entire movement region of the scroll button and the total number of pages, the entire movement region being divided into a plurality of scroll button regions; a storage unit to respectively associate the scroll button regions with corresponding pages and store the association result; and a display unit, in response to a movement of the scroll button to a specific scroll button region, to display, on the screen thereof, the network equipment information corresponding to the page associated with the specific scroll button region.

The control unit may determine the number of pieces of network equipment, information about which is able to be displayed on one page of the screen, and determine the total number of pages by dividing the total number of pieces of network equipment by the number of pieces of network equipment, information about which is able to be displayed on one page of the screen.

The control unit may determine the number of pieces of network equipment, information about which is able to be displayed on one page of the screen, by dividing a vertical or horizontal length of the screen by a vertical or horizontal length of one display block to display information about one piece of network equipment.

When a size of the screen is changed in a state of displaying on the screen the network equipment information corresponding to the page associated with the specific scroll button region, the control unit may re-determine the total number of pages in accordance with the changed size of the screen.

The control unit may determine the number of pieces of network equipment, information about which is able to be displayed on one page of the screen having the changed size, and determine the total number of pages by dividing the total number of pieces of network equipment by the number of pieces of network equipment, information about which is able to be displayed on one page of the screen having the changed size.

When the number of pieces of network equipment, information about which is able to be displayed on one page of the screen having the changed size is determined, the display unit may display information about the determined number of pieces of network equipment on the screen having the changed size.

The display unit may display information about the network equipment disposed at the highest block of the screen prior to the size change of the screen within the screen having the changed size.

The control unit may re-determine a length of a scroll button region corresponding to one page of the screen having the changed size based on a length of an entire movement region of the scroll button and the re-determined total number of pages.

The storage unit may re-associate the scroll button regions, each region having the re-determined length, with corresponding pages of the re-determined total number of pages and store the re-association result.

The network equipment may include an image forming apparatus, and the network equipment information may include status information of the image forming apparatus.

The status information of the image forming apparatus may include at least one of a network type, a toner consumption amount, a model name, an IP (internet protocol) address, a MAC address, and a jam occurrence.

In accordance with one aspect, it is possible to provide an operator with an intuitive and easy user interface when manipulating the network management apparatus to manage the network equipment.

### BRIEF DESCRIPTION OF THE DRAWINGS

These and/or other aspects will become apparent and more readily appreciated from the following description of the embodiments, taken in conjunction with the accompanying drawings of which:

FIG. 1 illustrates a network management apparatus according to one embodiment, and network equipment connected thereto;

FIG. 2 is a control block diagram of a network management apparatus according to one embodiment, and network equipment connected thereto;

FIG. 3A and FIG. 3B respectively illustrate network equipment information displayed on a screen of a network management apparatus according to one embodiment;

FIG. 4 is a view for illustrating how to calculate a length of a scroll button region corresponding to one page on a screen of a network management apparatus according to one embodiment;

FIG. 5A is a view for illustrating the size change of a screen of a network management apparatus according to one embodiment;

FIG. 5B is a view for illustrating a state in which, prior to the size change of a screen of a network management apparatus according to one embodiment, a pointer points to information about network equipment disposed at the highest block of the screen;

FIG. 5C is a view for illustrating a state in which, after the size change of a screen of a network management apparatus according to one embodiment, the information about the network equipment pointed to by the pointer in FIG. 5B is still displayed at a current screen having the changed size.

FIG. 5D to FIG. 5F illustrate that, when changing the size of a screen of a network management apparatus according to one embodiment, information about network equipment pointed to by a pointer prior to the size change of the screen is located in a current page of a screen with the changed size.

FIG. 6 illustrates that, when clicking on a scroll button on a screen of a network management apparatus according to one embodiment, a help information balloon is displayed;

FIG. 7 is a control flow-chart for displaying information about network equipment on a screen of a network management apparatus according to one embodiment;

FIG. 8 is a control flow-chart performed when a location of a scroll button or a size of a screen is changed via manipulation of a user interface by an operator in a state in which information about network equipment is displayed on a screen of a network management apparatus according to one embodiment.

### DETAILED DESCRIPTION

Reference will now be made in detail to the embodiments, examples of which are illustrated in the accompanying drawings, wherein like reference numerals refer to like elements throughout.

Below, various embodiments will be described in detail with reference to the accompanying drawings.

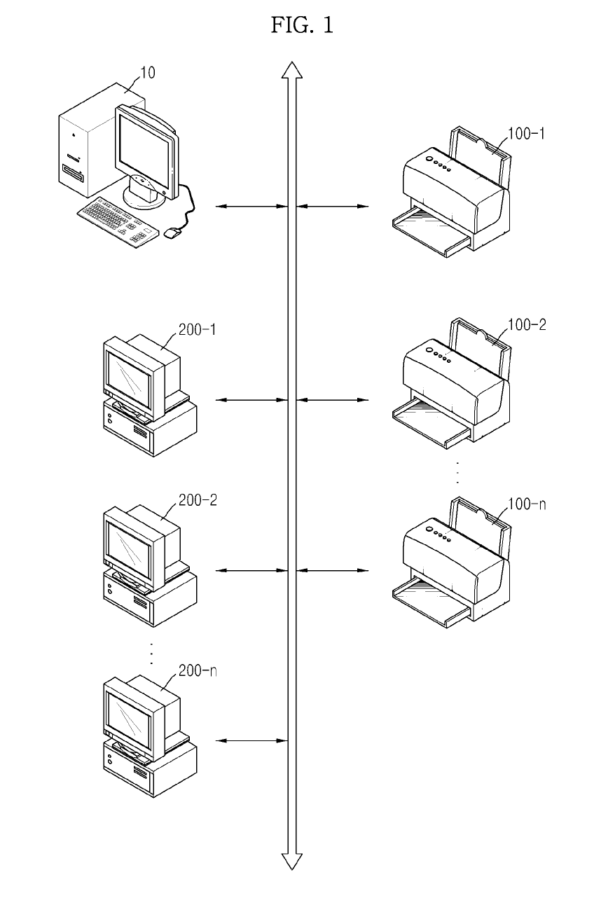

FIG. 1 illustrates a network management apparatus according to one embodiment, and network equipment connected thereto. In the accompanying drawings, for the convenience of explanation, network equipment is exemplified as an image forming apparatus, and a network management apparatus is exemplified as a server or host apparatus for an image forming apparatus. However, the present invention is not limited thereto.

The network management apparatus 10 may be connected to at least one piece of network equipment 100-1, 100-2 . . . 100-n. The network management apparatus 10 may be a server for an image forming apparatus. The network management apparatus 10 may be a separate apparatus from host apparatuses 200-1, 200-2 . . . 200-n. Alternatively, any one of the host apparatuses 200-1, 200-2 . . . 200-n may function as the network management apparatus 10. In the latter case, the network management apparatus 10 may be included in a corresponding one of the host apparatuses 200-1, 200-2 . . . 200-n.

The network management apparatus 10 may be connected to at least one piece of network equipment 100-1, 100-2 . . . 100-n and manage information about the connected network equipment 100-1, 100-2 . . . 100-n.

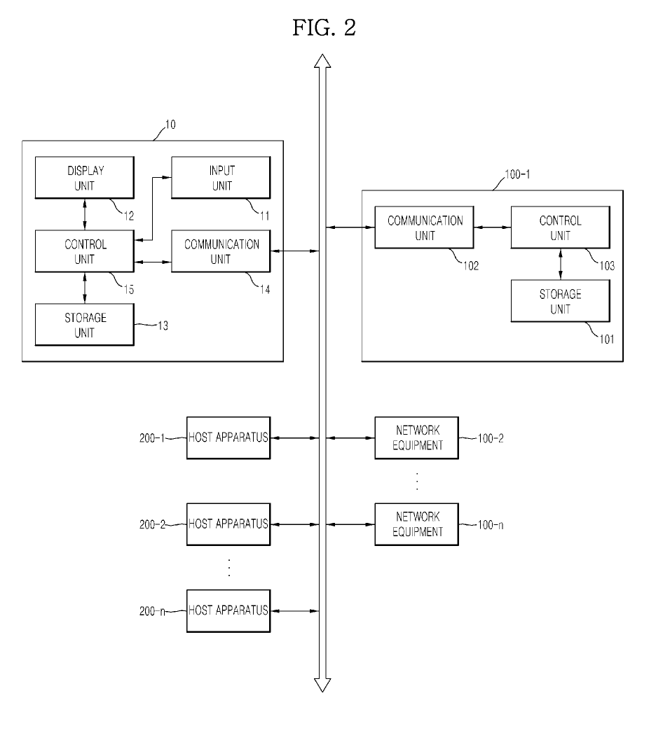

FIG. 2 is a control block diagram of a network management apparatus according to one embodiment, and network equipment connected thereto.

The network management apparatus 10 may include an input unit 11, a display unit 12, a storage unit 13, a communication unit 14, and a control unit 15.

The input unit 11 of the network management apparatus 10 may include an input device such as a keyboard or a mouse, for example. The input unit 11 of the network management apparatus 10 may include a graphical user interface (GUI) generated by executing a driver or a separate application.

The display unit 12 of the network management apparatus 10 may display information about the network equipment 100-1, 100-2 . . . 100-n distributed over a network. The display unit 12 of the network management apparatus 10 may display information about each piece of the network equipment 100-1, 100-2 . . . 100-n distributed over a network on a display block basis. The display unit 12 of the network management apparatus 10 may display information about the network equipment 100-1, 100-2 . . . 100-n page by page. The display unit 12 of the network management apparatus 10 may display a scroll button at one side of the screen thereof. The scroll button may be a user interface to enable the user to turn the page by moving the scroll button.

The storage unit 13 of the network management apparatus 10 may store therein information about each piece of the network equipment 100-1, 100-2 . . . 100-n distributed over a network. The storage unit 13 of the network management apparatus 10 may update in real-time and store information about each piece of the network equipment 100-1, 100-2 . . . 100-n.

The communication unit 14 of the network management apparatus 10 may communicate with at least one piece of network equipment 100-1, 100-2 . . . 100-n in compliance with a given communication protocol. The communication unit 14 of the network management apparatus 10 may collect status information or identity information of at least one piece of network equipment 100-1, 100-2 . . . 100-n.

The control unit 15 of the network management apparatus 10 may calculate, in response to an instruction input by an operator using the input unit 11 to display information about each piece of the connected network equipment 100-1, 100-2 . . . 100-n, the number of pieces of network equipment 100-1, 100-2 . . . 100-n, information about which the display unit 12 may display on a single screen thereof.

The control unit 15 of the network management apparatus 10 may calculate the number of pieces of network equipment 100-1, 100-2 . . . 100-n, information about which the display unit 12 may display on one page of the screen thereof, based on the number of pixels corresponding to a vertical or horizontal length of the screen to display information about the network equipment 100-1, 100-2 . . . 100-n and the number of pixels corresponding to a vertical or horizontal length of one display block to display information about one piece of the network equipment 100-1, 100-2 . . . 100-n.

The number of pieces of network equipment, information about which is able to be displayed on one page of a screen=The number of pixels corresponding to a vertical or horizontal length of the screen/the number of pixels corresponding to a vertical or horizontal length of one display block to display information about one piece of network equipment. Expression (1)

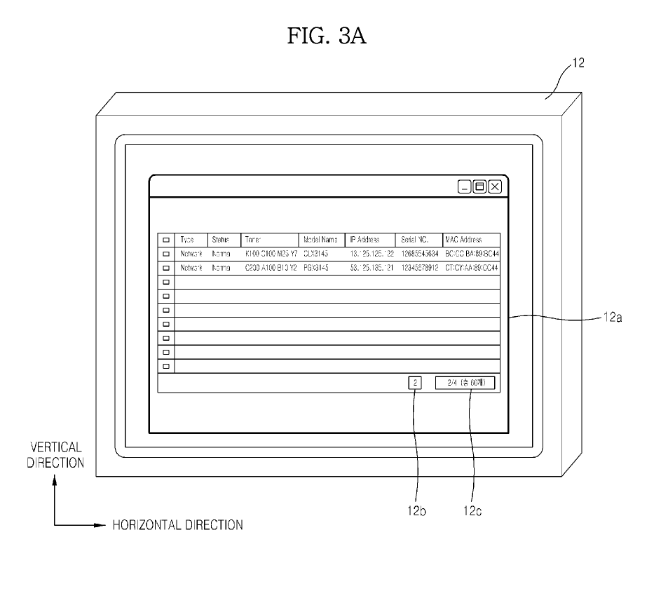

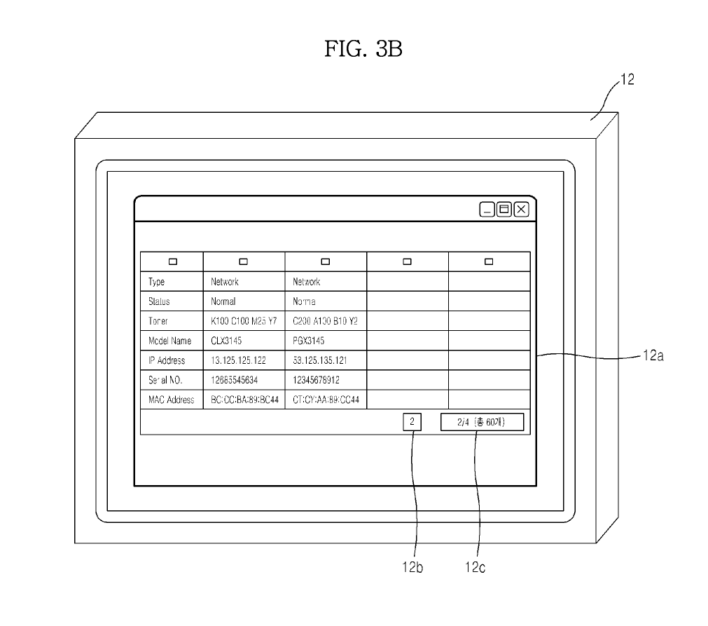

Referring to FIG. 3A, the display unit 12 of the network management apparatus 10 is exemplified as a monitor. The monitor may display a screen 12a having a variable size via an operator's manipulation. Horizontal and vertical lengths of the screen may be varied in accordance with a drag operation by the operator. In FIG. 3A, information about each piece of the network equipment 100-1, 100-2 . . . 100-n are arranged in a horizontal direction of the screen. In this case, the number of pieces of network equipment, information about which is able to be displayed on one page of the screen, may be determined by dividing the number of pixels corresponding to a vertical length of the screen by the number of pixels corresponding to a vertical length of one display block to display information about one piece of the network equipment 100-1, 100-2 . . . 100-n. The screen 12a may be provided with a page shortcut block 12b and a current/total pages block 12c at a lower portion thereof.

When the network equipment 100-1, 100-2 . . . 100-n is an image forming apparatus, information about each piece of the network equipment 100-1, 100-2 . . . 100-n may include status information about the image forming apparatus. The status information about the image forming apparatus may include information such as a network type, a toner consumption amount, a model name, an IP (Internet protocol) address, a MAC address, or a jam occurrence, for example.

Referring to FIG. 3B, information about each piece of the network equipment 100-1, 100-2 . . . 100-n are arranged in a vertical direction of the screen 12a. In this case, the number of pieces of network equipment, information about which is able to be displayed on one page of the screen, may be determined by dividing the number of pixels corresponding to a horizontal length of the screen by the number of pixels corresponding to a horizontal length of one display block to display information about one piece of the network equipment 100-1, 100-2 . . . 100-n.

The control unit 15 of the network management apparatus 10 may calculate the total number of pages based on the total number of the network equipment 100-1, 100-2 . . . 100-n and the number of pieces of network equipment 100-1, 100-2 . . . 100-n, information about which is able to be displayed on one page of the screen. As indicated by the following Expression (2), the total number of pages may be determined by dividing the total number of the network equipment 100-1, 100-2 . . . 100-n by the number of pieces of network equipment 100-1, 100-2 . . . 100-n, information about which is able to be displayed on one page of the screen. At this time, if there is a remainder, the total number of pages may be obtained by adding “1” to the quotient of the dividing result.

The total number of pages=The total number of the network equipment/The number of pieces of network equipment, information about which is able to be displayed on one page of the screen (here, if there is a remainder, “1” being added to the quotient of the dividing result). Expression (2)

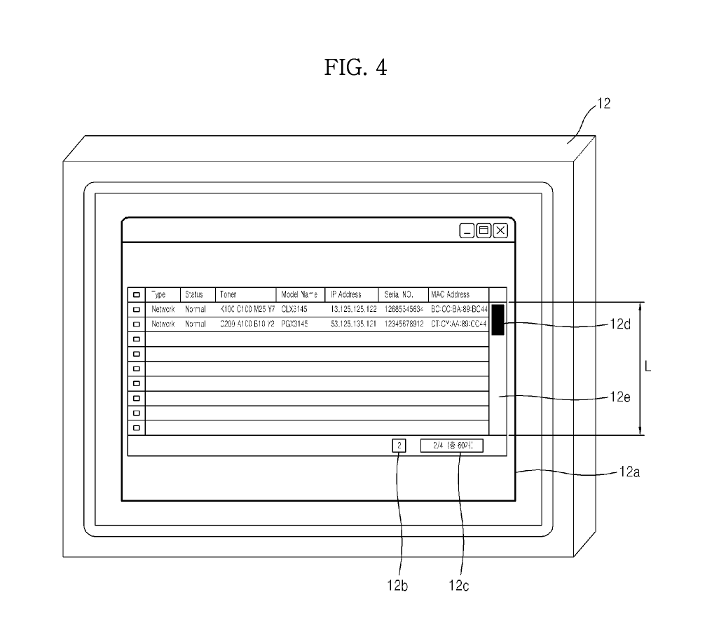

The control unit 15 of the network management apparatus 10 may calculate a length of a scroll button region corresponding to one page of the screen. Referring to FIG. 4, a scroll button 12d is located at a right side of the screen of displaying information about each piece of the network equipment 100-1, 100-2 . . . 100-n. The location of the scroll button 12d is not limited thereto. The scroll button 12d may move upward or downward and the page is turned accordingly. The control unit 15 of the network management apparatus 10 may calculate the length of the scroll button 12d region corresponding to one page based on a length L of an entire movement region 12e of the scroll button 12d and the total number of pages. As indicated by the following Expression (3), the length of the scroll button 12d region corresponding to one page may be determined by dividing the length L of the entire movement region 12e of the scroll button 12d by the total number of pages.

The length of the scroll button region corresponding to one page=The length of the entire movement region of the scroll button/The total number of pages. Expression (3),

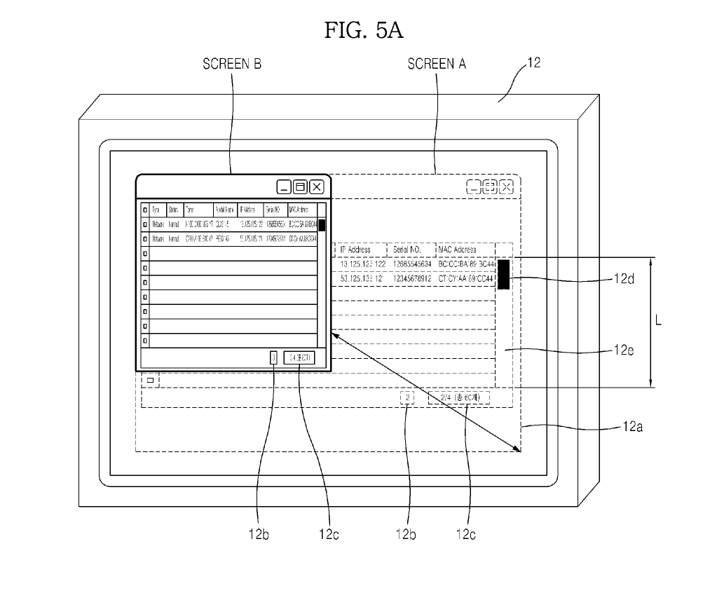

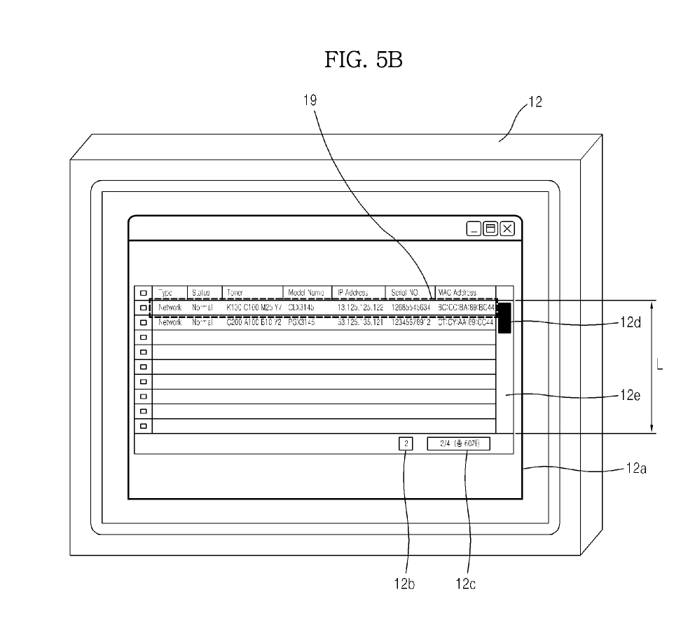

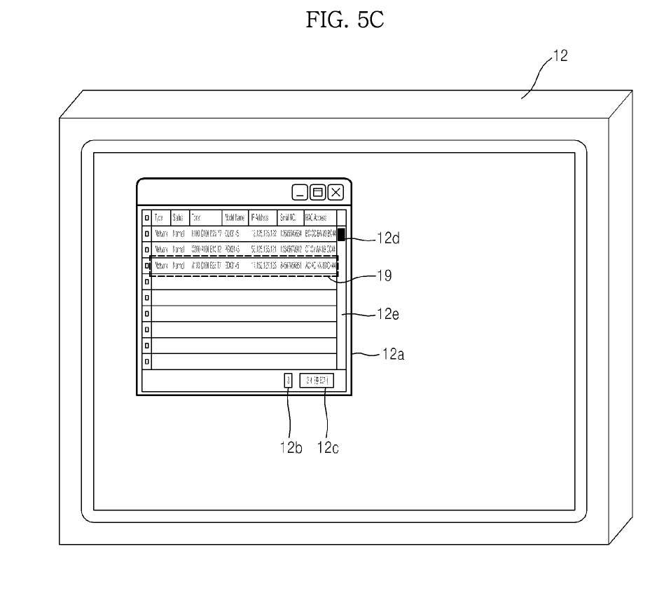

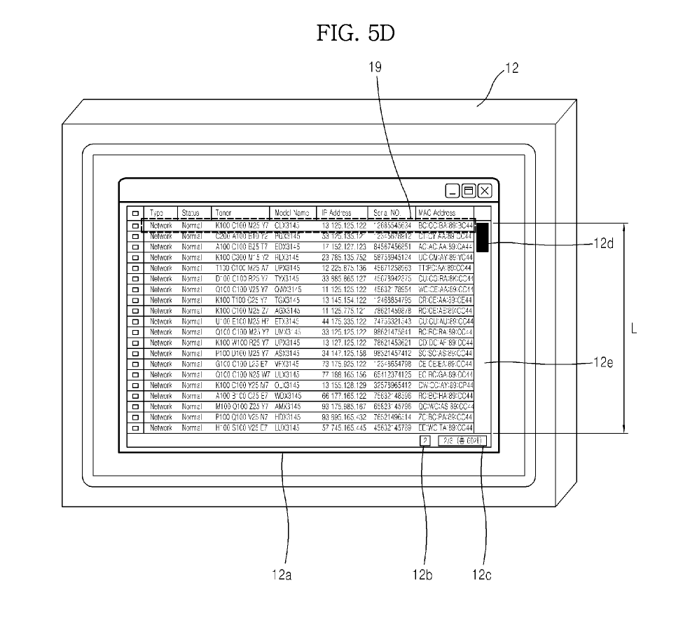

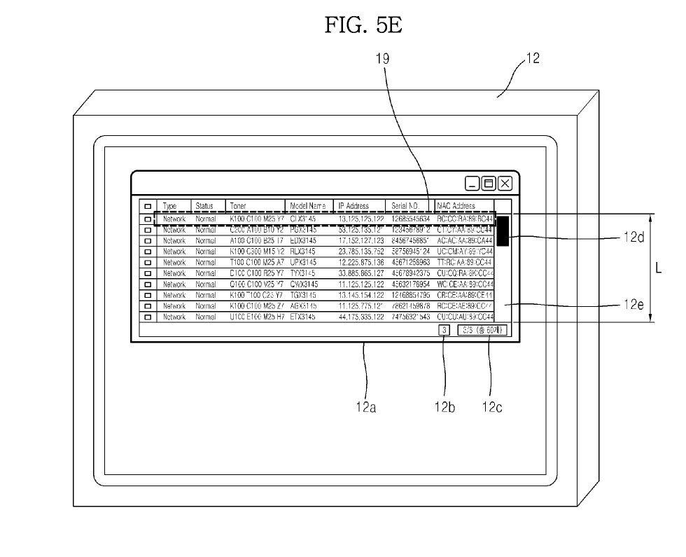

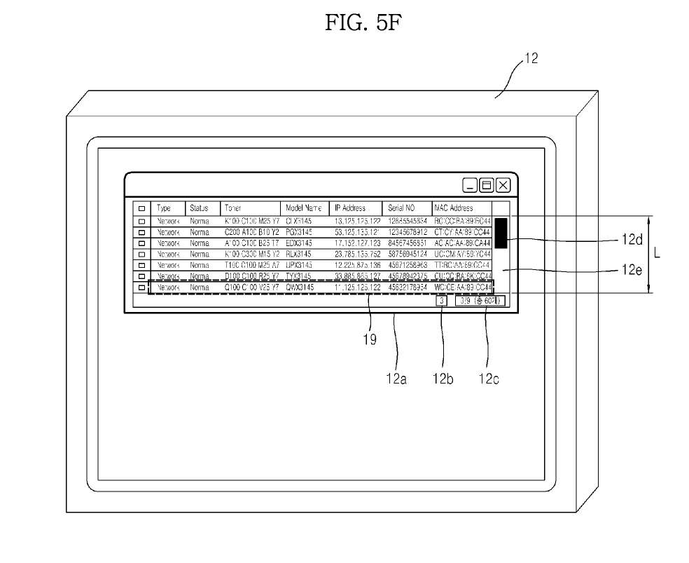

When the operator changes the size of the screen, the control unit 15 of the network management apparatus 10 may again perform the above-described calculations in accordance with the Expression (1), Expression (2), and Expression (3). FIG. 5A illustrates a case in which the size of the screen is reduced from a size of a screen A to a size of a screen B. In this case, the control unit 15 of the network management apparatus 10 calculates the number of pieces of network equipment, information about which is able to be displayed on one page of the screen B, based on the Expression (1) and controls the display unit 12 of the network management apparatus 10 to display information about each of the calculated number of pieces of network equipment 100-1, 100-2 . . . 100-n on the screen B thereof. The control unit 15 of the network management apparatus 10 calculates the total number of pages based on the Expression (2) and then calculates the length of the scroll button 12d region corresponding to one page based on the Expression (3).

In response to the change of the screen size, the control unit 15 of the network management apparatus 10 may be configured to allow information about one specific piece of the network equipment 100-1, 100-2 . . . 100-n displayed in the screen prior to the size change to be displayed in the screen having the changed size. For example, referring to FIG. 5B, the control unit 15 of the network management apparatus 10 identifies information 19 on the network equipment disposed on the highest block of the screen prior to the size change of the screen. Referring to FIG. 5C, the information 19 on the network equipment disposed on the highest block of the screen in FIG. 5B is displayed in the changed screen.

Referring to FIG. 5D and FIG. 5E in which the total number of the network equipment 100-1, 100-2 . . . 100-n is 60, the size of screen is reduced such that a state in which information about each piece of twenty network equipment 100-1, 100-2 . . . 100-n are displayed in a horizontal direction on one page of the screen is changed to a state in which information about each piece of ten network equipment 100-1, 100-2 . . . 100-n are displayed in a horizontal direction on one page of the screen. Referring to FIG. 5D, prior to the size change of the screen, the total number of pages is 3 (60/20) and a currently displayed page is the second page, and, thus, information 19 on the network equipment disposed at the highest block of the current page is information about 21st network equipment. Referring to FIG. 5E, after the size change of the screen, the total number of pages is 6 (60/10) and, thus, the information 19 on the 21st network equipment is located on the third page, and, hence, a currently displayed page is turned to the third page.

Referring to FIG. 5D and FIG. 5F in which the total number of the network equipment 100-1, 100-2 . . . 100-n is 60, the size of screen is reduced such that a state in which information about each piece of twenty network equipment 100-1, 100-2 . . . 100-n are displayed in a horizontal direction on one page of the screen is changed to a state in which information about each piece of seven network equipment 100-1, 100-2 . . . 100-n are displayed in a horizontal direction on one page of the screen. Referring to FIG. 5D, prior to the size change of the screen, the total number of pages is 3 (60/20) and a currently displayed page is the second page, and, thus, information 19 on the network equipment disposed at the highest block of the current page is information about 21st network equipment. Referring to FIG. 5F, after the size change of the screen, the total number of pages is 9 (60/7 having a quotient of “8” and a remainder of “4”, and, thus, “1” being added to the quotient) and, thus, the information 19 on the 21st network equipment is located on the third page, and, hence, a currently displayed page is turned to the third page. At this time, the information 19 on the 21st network equipment is displayed at the lowest block of the third page.

In response to movement of the scroll button 12d by the operator, the control unit 15 of the network management apparatus 10 may be configured to allow the screen to display a page corresponding to the movement region of the scroll button 12d. The movement of the scroll button 12d may be carried out by dragging the scroll button 12d or by clicking on any given location within the entire movement region 12e of the scroll button 12d. The scroll button 12d may be a user interface to enable page-turning. Each page of the total pages may correspond to each of the scroll button 12d regions within the entire movement region 12e of the scroll button 12d.

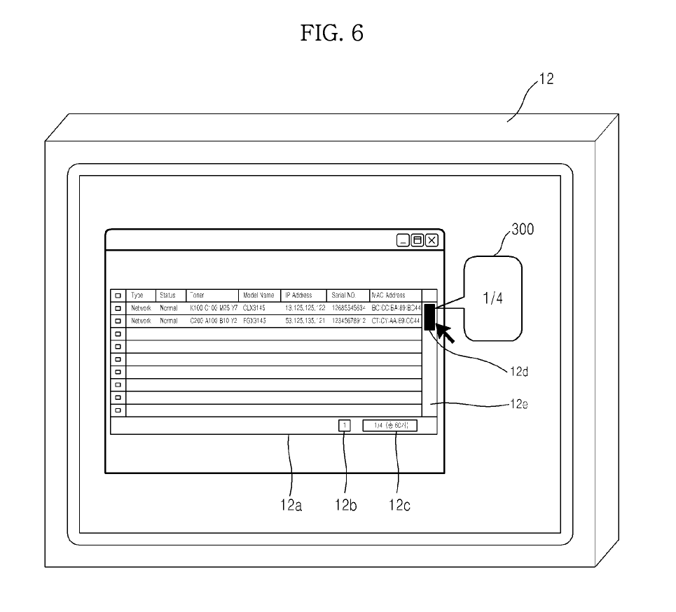

When the operator clicks on the scroll button 12d on a current page, the control unit 15 of the network management apparatus 10 may be configured to allow help information showing a current page number and a total page number to pop up. Referring to FIG. 6, when the operator clicks on the scroll button 12d using the mouse, balloon help information 300 pops up. This balloon help information may provide various information such as a current page number, a total page number, or the total number of the pieces of network equipment, for example.

Each piece of network equipment 100-1, 100-2 . . . 100-n may include a storage unit 101, a communication unit 102, and a control unit 103.

The storage unit 101 of the network equipment may store therein, for example, printing data received from the corresponding host apparatus 200-1, 200-2 . . . 200-n and toner consumption information. The storage unit 101 of the network equipment may include an embedded storage medium such as an HDD (hard disk drive), or a USB port connectable to a portable storage medium such as a USB memory or a memory card, for example.

The communication unit 102 of the network equipment may include a wired or wireless communication module communicating over a network via a local protocol or any other given protocol with external apparatuses such as the network management apparatus 10 and the host apparatuses 200-1, 200-2 . . . 200-n; or a USB port connectable to a portable storage medium such as a USB memory or a memory card; for example.

The control unit 103 of the network equipment may be configured, in response to a receipt of an information send command from the network management apparatus 10, to allow attribute information of the corresponding network equipment 100-1, 100-2 . . . 100-n to be sent to the network management apparatus 10. In addition to the attribute information, the control unit 103 of the network equipment may be configured to allow consumption information or status information, for example, of the corresponding network equipment 100-1, 100-2 . . . 100-n to be sent to the network management apparatus 10.

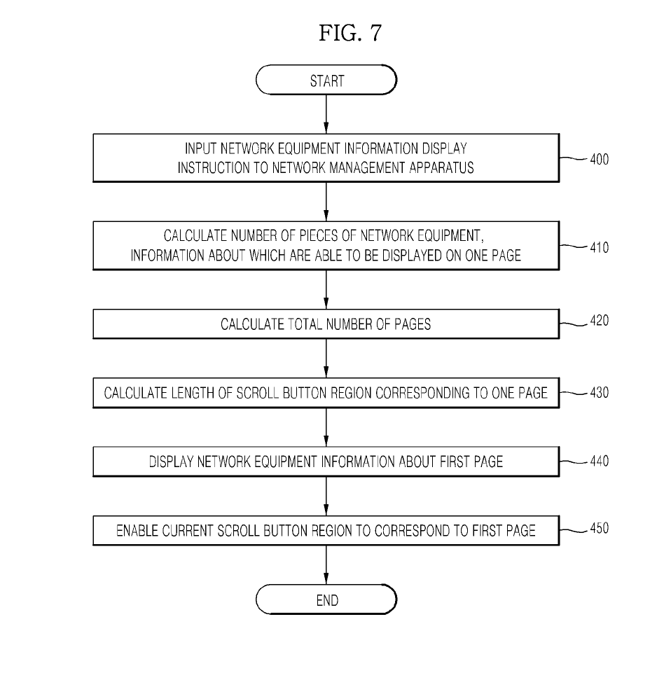

FIG. 7 is a control flow chart for displaying information about network equipment on a screen of a network management apparatus according to one embodiment.

When an operator inputs an instruction entailing displaying information about each piece of the network equipment 100-1, 100-2 . . . 100-n, the control unit 15 of the network management apparatus 10 determines the number of pieces of network equipment 100-1, 100-2 . . . 100-n, information about which is able to be displayed on one page of the screen. The operator may operate the input unit 11 of the network management apparatus 10 to allow information about the determined number of pieces of network equipment 100-1, 100-2 . . . 100-n to be displayed on a current page of the screen. As mentioned above, the number of pieces of network equipment 100-1, 100-2 . . . 100-n, information about which is able to be displayed on one page of the screen may be calculated based on the number of pixels corresponding to a vertical or horizontal length of the screen to display information about the network equipment 100-1, 100-2 . . . 100-n and the number of pixels corresponding to a vertical or horizontal length of one display block to display information about one piece of the network equipment 100-1, 100-2 . . . 100-n (operation 400 and 410).

The control unit 15 of the network management apparatus 10 determines the total number of pages. As mentioned above, the total number of pages may be calculated based on the total number of the network equipment 100-1, 100-2 . . . 100-n and the number of pieces of network equipment 100-1, 100-2 . . . 100-n, information about which is able to be displayed on one page of the screen (operation 420).

The control unit 15 of the network management apparatus 10 determines a length of a scroll button region corresponding to one page of the screen. As mentioned above, the control unit 15 of the network management apparatus 10 may calculate the length of the scroll button 12d region corresponding to one page based on a length L of an entire movement region 12e of the scroll button 12d and the total number of pages (operation 430).

The control unit 15 of the network management apparatus 10 may control the display unit 12 to display information about each piece of the network equipment 100-1, 100-2 . . . 100-n on one page or any given page. The control unit 15 of the network management apparatus 10 may control the display unit 12 to display information about each of the determined number of pieces of network equipment 100-1, 100-2 . . . 100-n on one page. When displaying information about each piece of the network equipment 100-1, 100-2 . . . 100-n on the screen, the control unit 15 of the network management apparatus 10 may control the display unit 12 to display a page shortcut block and a current/total pages block, or the like at a lower portion of the screen (operation 440).

The control unit 15 of the network management apparatus 10 may enable a current scroll button 12d region to correspond to a first page. The control unit 15 of the network management apparatus 10 may control the display unit 12 to display information about each of the determined number of pieces of network equipment 100-1, 100-2 . . . 100-n on a first page, and enable the scroll button 12 to be located at the highest position of the entire movement region 12e (operation 450).

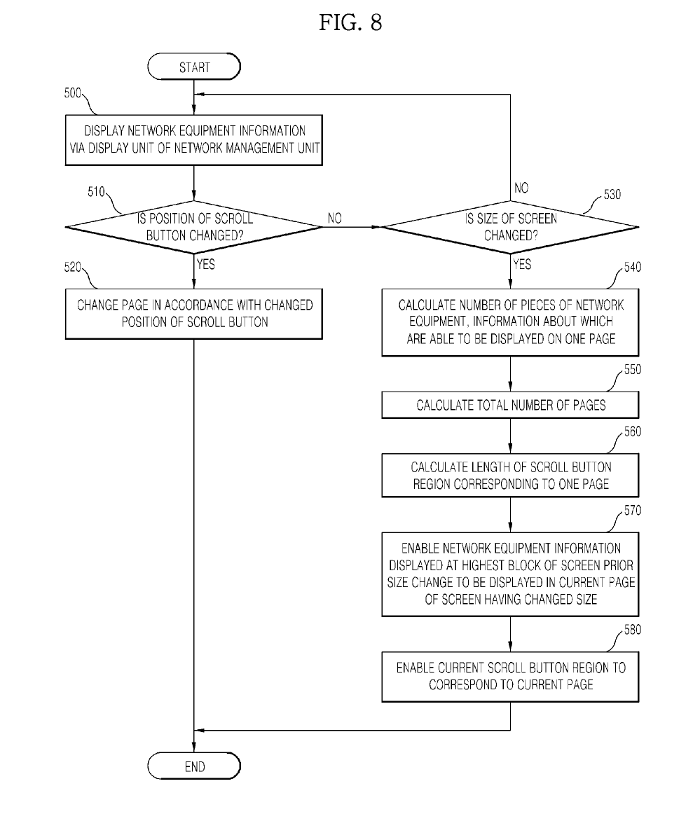

FIG. 8 is a control flow chart performed when a location of a scroll button or a size of a screen is changed via manipulation of a user interface by an operator in a state in which information about network equipment are displayed on a screen of a network management apparatus according to one embodiment.

The display unit 12 of the network management apparatus 10 displays the network equipment information in accordance with the control flow-chart of FIG. 7 (operation 500).

The control unit 15 of the network management apparatus 10 may determine whether a position of the scroll button 12d on the screen is changed. The operator may move the scroll button 12d by dragging the scroll button 12d or by clicking on any given position within the entire movement region 12e (operation 510).

Upon determining that a position of the scroll button 12d on the screen is changed, the control unit 15 of the network management apparatus 10 may control the display unit 12 to display a page corresponding to a current scroll button 12d region onto which the scroll button 12d has moved (operation 520).

The control unit 15 of the network management apparatus 10 may determine whether a size of the screen to display information about the network equipment 100-1, 100-2 . . . 100-n is changed. The operator may adjust the size of the screen to display information about the network equipment 100-1, 100-2 . . . 100-n, for example, by dragging an edge of the screen. That is, the display unit 12 always has a fixed size of a full screen, but, the screen to display information about the network equipment 100-1, 100-2 . . . 100-n may have a variable size (operation 530).

Upon determining that the size of the screen to display information about the network equipment 100-1, 100-2 . . . 100-n is changed, the control unit 15 of the network management apparatus 10 may re-determine the number of pieces of network equipment, information about which is able to be displayed on one page of the screen having the changed size (operation 540).

The control unit 15 of the network management apparatus 10 may re-determine the total number of pages in accordance with the changed size of the screen. The control unit 15 of the network management apparatus 10 may re-calculate the total number of pages based on the total number of pieces of network equipment and the number of pieces of network equipment, information about which is able to be displayed on one page of the screen having the changed size (operation 550).

The control unit 15 of the network management apparatus 10 may re-determine a length of a scroll button region corresponding to one page of the screen having the changed size. The control unit 15 of the network management apparatus 10 may re-calculate a length of a scroll button region corresponding to one page of the screen having the changed size, based on a length of an entire movement region of the scroll button and the re-determined total number of pages (operation 560).

The control unit 15 of the network management apparatus 10 may enable information about the network equipment 100-1, 100-2 . . . 100-n disposed at the highest block of the screen prior to the size change of the screen to be displayed within the screen having the changed size. The control unit 15 of the network management apparatus 10 may set a pointer to the information about the network equipment 100-1, 100-2 . . . 100-n disposed at the highest block of the screen prior to the size change of the screen and control the display unit 12 to display the information about the network equipment 100-1, 100-2 . . . 100-n pointed to by the pointer prior to the size change of the screen on the screen having a change size (operation 570).

The control unit 15 of the network management apparatus 10 may enable a current page to correspond to a current scroll button 12d region (operation 580).

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of controlling a network management apparatus comprising a screen to display information about each piece of network equipment and a scroll button on the screen to enable a change of the screen in displaying the network equipment information, the method comprising:
determining a total number of pages to display the network equipment information based on the number of pieces of network equipment;
determining a length of a scroll button region corresponding to one page based on a length of an entire movement region of the scroll button and the total number of pages, the entire movement region being divided into a plurality of scroll button regions;
respectively associating the scroll button regions with corresponding pages and storing the association result; and
in response to movement of the scroll button to a specific scroll button region, displaying, on the screen, the network equipment information corresponding to the page associated with the specific scroll button region.

2. The method of claim 1, wherein determining the total number of pages comprises:
determining the number of pieces of network equipment, information about which is able to be displayed on one page of the screen; and
determining the total number of pages by dividing the total number of pieces of network equipment by the number of pieces of network equipment, information about which is able to be displayed on one page of the screen.

3. The method of claim 2, wherein determining the number of pieces of network equipment, information about which is able to be displayed on one page of the screen, comprises determining the number of pieces of network equipment, information about which is able to be displayed on one page of the screen, by dividing a vertical or horizontal length of the screen by a vertical or horizontal length of one display block to display information about one piece of network equipment.

4. The method of claim 1, further comprising, when a size of the screen is changed in a state of displaying on the screen the network equipment information corresponding to the page associated with the specific scroll button region, re-determining the total number of pages in accordance with the changed size of the screen.

5. The method of claim 4, wherein re-determining the total number of pages in accordance with the changed size of the screen comprises:
determining the number of pieces of network equipment, information about which is able to be displayed on one page of the screen having the changed size; and
determining the total number of pages by dividing the total number of pieces of network equipment by the number of pieces of network equipment, information about which is able to be displayed on one page of the screen having the changed size.

6. The method of claim 5, further comprising, when the number of pieces of network equipment, information about which is able to be displayed on one page of the screen having the changed size is determined, displaying information about the determined number of pieces of network equipment on the screen having the changed size.

7. The method of claim 6, wherein displaying information about the determined number of pieces of network equipment on the screen having the changed size comprises displaying information about the network equipment disposed at the highest block of the screen prior to the size change of the screen within the screen having the changed size.

8. The method of claim 4, further comprising re-determining a length of a scroll button region corresponding to one page of the screen having the changed size based on a length of an entire movement region of the scroll button and the re-determined total number of pages.

9. The method of claim 4, further comprising respectively re-associating the scroll button regions, each region having the re-determined length, with corresponding pages of the re-determined total number of pages and storing the re-association result.

10. A network management apparatus having a screen to display information about each piece of network equipment and a scroll button on the screen to enable a change of the screen in displaying the network equipment information, the apparatus comprising:
a control unit to determine a total number of pages to display the network equipment information based on the number of pieces of network equipment, and determine a length of a scroll button region corresponding to one page based on a length of an entire movement region of the scroll button and the total number of pages, the entire movement region being divided into a plurality of scroll button regions;
a storage unit to respectively associate the scroll button regions with corresponding pages and store the association; and
a display unit, in response to a movement of the scroll button to a specific scroll button region, to display, on the screen thereof, the network equipment information corresponding to the page associated with the specific scroll button region.

11. The apparatus of claim 10, wherein the control unit determines the number of pieces of network equipment, information about which is able to be displayed on one page of the screen, and determines the total number of pages by dividing the total number of pieces of network equipment by the number of pieces of network equipment, information about which is able to be displayed on one page of the screen.

12. The apparatus of claim 11, wherein the control unit determines the number of pieces of network equipment, information about which is able to be displayed on one page of the screen, by dividing a vertical or horizontal length of the screen by a vertical or horizontal length of one display block to display information about one piece of network equipment.

13. The apparatus of claim 10, wherein when a size of the screen is changed in a state of displaying on the screen the network equipment information corresponding to the page associated with the specific scroll button region, the control unit re-determines the total number of pages in accordance with the changed size of the screen.

14. The apparatus of claim 13, wherein the control unit determines the number of pieces of network equipment, information about which is able to be displayed on one page of the screen having the changed size, and determines the total number of pages by dividing the total number of pieces of network equipment by the number of pieces of network equipment, information about which is able to be displayed on one page of the screen having the changed size.

15. The apparatus of claim 14, wherein when the number of pieces of network equipment, information about which is able to be displayed on one page of the screen having the changed size is determined, the display unit displays information about the determined number of pieces of network equipment on the screen having the changed size.

16. The apparatus of claim 15, wherein the display unit displays information about the network equipment disposed at the highest block of the screen prior to the size change of the screen within the screen having the changed size.

17. The apparatus of claim 13, wherein the control unit re-determines a length of a scroll button region corresponding to one page of the screen having the changed size based on a length of an entire movement region of the scroll button and the re-determined total number of pages.

18. The apparatus of claim 17, wherein the storage unit re-associates the scroll button regions, each region having the re-determined length, with corresponding pages of the re-determined total number of pages and stores the re-association result.

19. The apparatus of claim 10, wherein the network equipment include an image forming apparatus, and the network equipment information includes status information of the image forming apparatus.

20. The apparatus of claim 19, wherein the status information of the image forming apparatus includes at least one of a network type, a toner consumption amount, a model name, an IP (internet protocol) address, a MAC address, and a jam occurrence.

21. A non-transitory computer-readable recording medium storing a program to implement the method of claim 1.
